(19) United States
(12) Patent Application Publication
(10) Pub. No.: US 2020/0364034 A1
(43) Pub. Date: Nov. 19, 2020

(54) System and Method for Automated Code Development and Construction

(71) Applicant: GSIX, Inc., Denver, CO (US)

(72) Inventors: Teodos Pejoski, Skopje (MK); Andrej Kolarovski, Skopje (MK)

(21) Appl. No.: 16/746,693

(22) Filed: Jan. 17, 2020

Related U.S. Application Data
(60) Provisional application No. 62/793,549, filed on Jan. 17, 2019.

(51) Int. Cl. G06F 8/34; G06F 8/38; G06T 7/00; G06T 5/00; G06N 3/02

(52) U.S. Cl. CPC G06F 8/34; G06F 8/38; G06N 3/02; G06T 5/002; G06T 7/0002

(57) ABSTRACT

A software invention for receiving input capturing one or more application designs and converting such designs into configurable source code is disclosed. The software performs initial processing of any such input to optimize object and boundary detection, detect each relevant contour or boundary location, creates a hierarchical tree reflecting each components and its relative place in the hierarchy, each element is adjusted to insure that it falls within the boundary of its object frame, is optimized for viewing and utilization based on the dimensions of the target device and uses such information to generate editable and functional code using common software programming languages in order to provide a usable and fully functional software output.

### PRIORITY CLAIM

This application claims priority from a provisional application filed on Jan. 17, 2019, having application Ser. No. 62/793,549, which is hereby fully incorporated herein.

### BACKGROUND OF THE INVENTION

The process of building digital products nowadays is really slow, expensive and inefficient, given the technology and expertise we have available. People tend to not even start working on their product, just because it has been told that the process is long and expensive. If for example someone wants to build simple mobile application, the process would look similar to the following: Sketch the idea on paper; If you are a designer, you may design the app, if not you are trying to find someone who can design the app based on your sketches; Somewhere along those lines you need to find someone who can confirm if it is technically possible to do that (assuming that you are not technical person).

After you have the initial design, there are usually couple iterations before you get what you really envisioned, and more often than not, those iterations will result with critical changes on the engineering side, thus creating more work for the technical person (individual or a company) and significantly increasing the development cost to even get the initial app released.

For example, if a user wants to build an application for your business and that is not a core competency, it would be beneficial maybe (as it is nice to have app) you would prefer to create a trial or minimal viable application at a relatively low cost of time and money. Furthermore, many of the cases users want to quickly build applications in order to test the market viability of such apps and test the applicable market. What is needed then is a simple process for quickly building and constructing software applications based on preliminary ideas quickly and efficiently at a low cost so that users can validate the application and, if necessary, update and optimize such application in order to rapidly increase efficacy and time to market.

The present invention enables users to quickly prototype and build formal applications so that this initial framing step and basic programming can be streamlined and automated to enable quick and rapid application development with minimal knowledge of the code required to build an application on one or more relevant platforms. The present invention addresses this problem by creating a tool that will dramatically change the way we build digital products nowadays and shorten the whole process from months to minutes to create a minimum viable product that reflects the design.

### SUMMARY OF THE INVENTION

The current invention helps reduce the time and effort we put into creating digital products. Instead of knowing how to use design tools or programming languages, you can now simply describe your idea in a human understandable way (e.g. provide drawings). The invention is composed of 3 main components that can also function independently but in accordance with the present invention operate collectively in a sequential fashion.

The first component is a recognition device (e.g. mobile phone camera) or the Recognizer 110 that runs the software that is able to identify key forms of a digital product, their characteristics and attributes, resulting with a descriptive language that can be used by the code Generator 120.

The code Generator 120 is the second important component that runs another software that is able to produce meaningful output from the descriptive language. The code Generator 120 may also reshape the given (recognized) forms in a way that will be more meaningful for a given intended environment (i.e. many mobile application shapes are different than many website shapes). The code Generator 120 produces a meaningful output that can be executed independently on another device or multiple devices.

The third component of the invention is the Executor 130. The Executor 130 receives an input from a code Generator 120 (both directly and/or indirectly) and “runs” the output in a given environment.

Applying the methods and components outlined herein, the descriptive language and the output can be modified in any time manually provided a shared set of rules and language is being used by each component.

### BRIEF DESCRIPTION OF THE DRAWINGS

FIG. 1 shows a block diagram illustrating one or more components of the core functional modules of the present invention.

FIG. 2 is a sample image that can be used as input for the present invention and its hierarchical ordering.

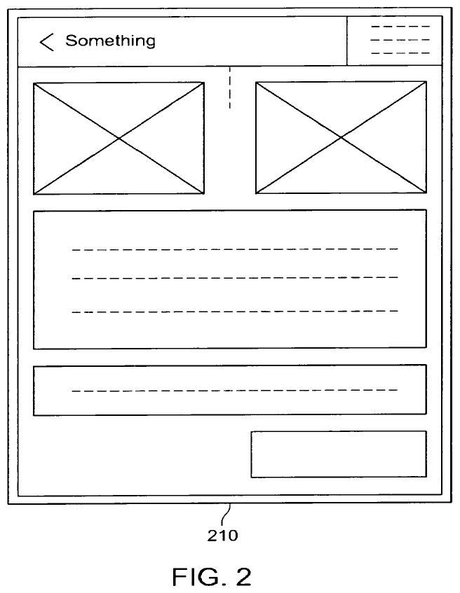

FIG. 3A is a second sample image that is used to help illustrate the functions of the present invention.

FIG. 3B is a sample image demonstrating the boundary identification and object recognition functionality.

FIG. 4 is a block diagram illustrating the core functional components of the Recognizer of the present invention

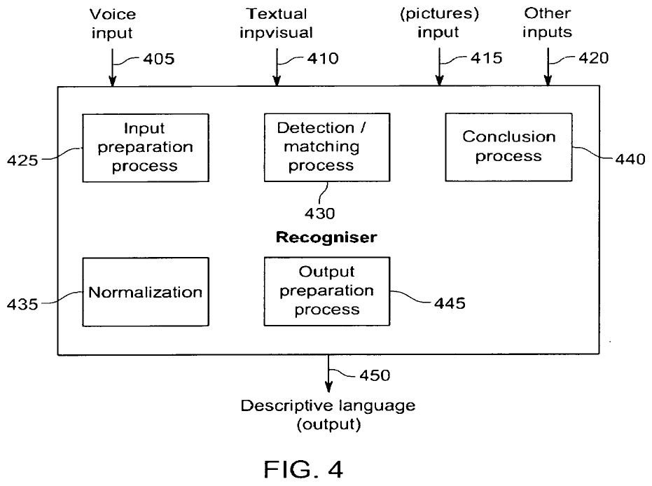

FIG. 5 is a visualization of the Recognizer's input and output.

FIG. 6 contains sample images from the dataset used to train the Recognizer.

### DETAILED DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s).

Accordingly, those skilled in the art will recognize that tone or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

A description of an embodiment with several components in concert with each other does not imply that all such components are required. On the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step).

Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

One or more other devices that are not explicitly described as having such functionality/features may alternatively embody the functionality and/or the features of a device. Thus, other embodiments of one or more of the invention(s) need not include the device itself.

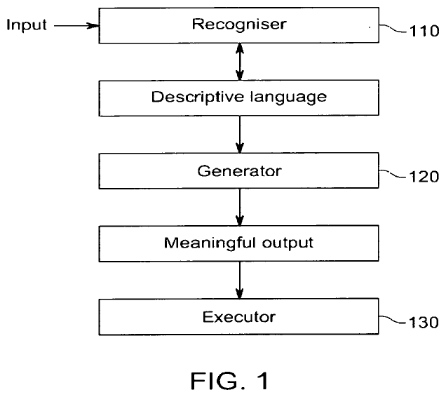

Referring now to FIG. 1, The main system of the present invention is composed of three components: Recognizer 110, a Generator 120, and an Executor 130. Their work can be summarized in the following steps:
1) The Recognizer 110 prepares the input for analysis (achieving max available contrast and noise cancellation, unnecessary word cleanup);
2) The Recognizer 110 detects and classifies all the UI elements in the input
3) The Recognizer 110 then provides this data to the Generator 120 using a descriptive language
4) The Generator 120 auto-aligns the detected elements (see below);
5) The Generator 120 formats the output of steps 3) and 4), in a simple manner describing the location of the elements on screen, and their type (Image, Button, Text input, etc.), as well as additional attributes if provided.;
6) The output provided by the Generator 120 is then used by the Executor 130 to generate working code for the detected/provided platform with minimal functionality.

The first in the chain is the Recognizer. To detect and recognize the elements of an application (images, buttons, text areas and fields, etc.) from a sketch, the Recognizer uses a Region Based Convolutional Neural Network trained to locate them on an image provided by the user. A neural network is, in fact, an algorithm used in machine learning that emulates the work of neurons in the human brain to learn how to recognize and classify meaningful data from some sort of input (e. g., detect shapes on an image, sound patterns in an audio file, etc.), based on what it's learned during one or multiple training sessions from labeled datasets, containing positive samples (the part of the image a user wishes to be recognized) and negative samples (any other visual information). The dataset labels provide the following information to the neural network: the class of the object to be recognized in an image and its location in the image. In practice, a dataset is often contained of a huge amount of images, that come along with a markup file providing information on where is an object located (its bounding box) and which class does it belong to, for each image. Parts of the image within a bounding box would be treated as positive samples, ones out of a bounding box would become negative samples. Some part of the dataset (25% in our case) is used as a validation set, the rest is used for training.

Convolutional neural network (CNN) is a type of neural network commonly used in image recognition. While a regular CNN can only be used to tell if there is some object in an image, a Region Based CNN (RCNN) can detect multiple objects of different classes as well as point out their location, a key feature for this component of the invention. There are a couple of types of RCNNs, such as regular RCNN, Fast RCNN and Faster RCNN, of which for this invention the applicant believes the faster RCNN is the best mode due to significantly faster training time so will be used to help illustrate one embodiment of the invention. Those in the industry will understand that alternative neural network frameworks or other tools may also be used.

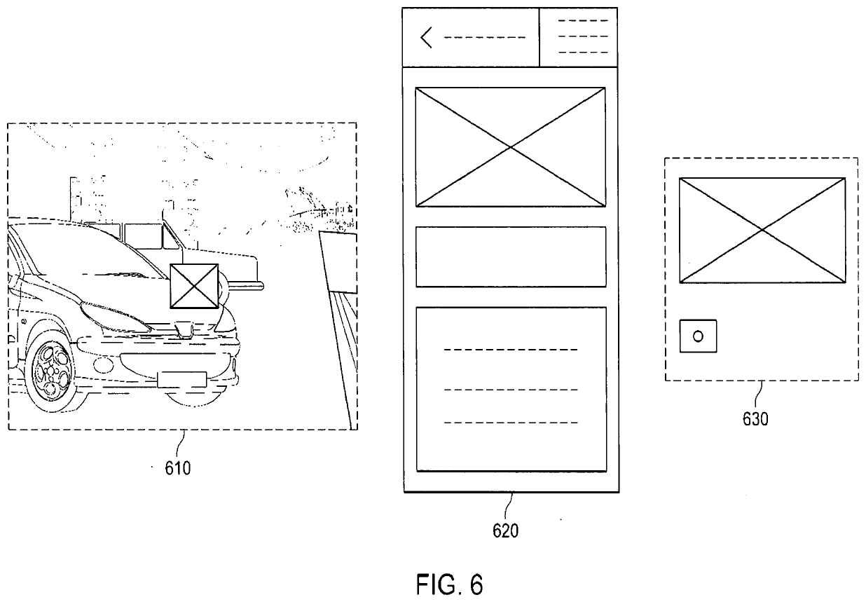

To train the Faster RCNN, in the preferred embodiment, a dataset containing hand-drawn sketches of full app screens as well as only screen elements, on different color- and content-intense backgrounds will be used to make sure the algorithm is provided with as much negative samples as possible. The hand-drawn images are passed through random distortions and transformations, then pasted randomly over various images, to create a huge (5000-10000) set of images. Sample images used as input are further illustrated in FIG. 6.

The second portion of the dataset contains images of actual sketches, both hand-drawn and computer generated, also labeled, which is the input data we expect the Recognizer to have during real life usage. Once the training using the first dataset is completed, it will be much easier for the Recognizer 110 to learn and detect app components on these sketches.

The reason for using this two-part dataset is that if one were to use only app sketch images, there will be not enough negative data for the Recognizer 110 to learn, as in all of the cases, the background (which is the negative data in our case) is just plain color, mostly white.

FIG. 6 shows samples of images we use for our dataset. As shown in 610, first we feed images of app components pasted over random pictures with intense color and content, to provide as much negative data as possible. Once this part of the training is completed (i.e. the Recognizer has high accuracy rate detecting app components in such images), the second stage of the training begins. For that second stage, we use hand-drawn (620) and computer-generated (630) sketches, the latter being generated similarly to how 610 is generated.

The training is done in several epochs. At the end of each epoch, the trained model is saved to a file that could be used for detection or further training. In the preferred embodiment of the invention, each next epoch and next stage of the training uses the previous model that is provided as output so that it can continue to be refined over time. This process of training the network may be performed on either a CPU or GPU. Given that the training can be a lengthy process, it is also preferable to use parallel processing to quicken up the pace.

The readiness of the trained model can be measured by its accuracy and loss rate. If the accuracy is well over 90% (in our case as high as 98%-99%) the model can be considered ready to use. A preferred practice for continued optimization would be to store all the user input, a naturally random and huge dataset, to use for further training.

The output of the Recognizer 110 would be a set of detected elements, with at least three core components that describe them: their class (application frame, button, image, etc.), the X and Y coordinates of their top left corner and the X and Y coordinates of their bottom corner. In practice, this would be a simple array of objects written in any programming language (Python in the embodiment disclosed herein).

As referred to above, the second component is the Generator 120 that will receive a description of the contents of the sketch as an input and generates meaningful output for a specific platform at a given moment depending on the type of input. E.g. a mobile screen will result in a mobile application meaningful output or web format depending on user selection.

For example, a button might appear to be the same component on iOS™ and Android™ but the behavior of it might be different. Such a navigation component in iOS™ has different behavior, look and feel than navigation component on Android. As a result, while the process will be described with reference to a sample platform, it should be understood that the specific outputs generated will vary depending on the target platform of the output of such generation.

As an initial matter, the Generator 120 either receives input or makes an educated guess regarding the platform/device code for which it needs to generate relevant output. For example, when it comes to pictures, it is easier to spot the difference between iOS, Android and Web based on the position of different components, size of the screen, and other attributes. Additionally the platform could be set based on a default setting in the generator 120.

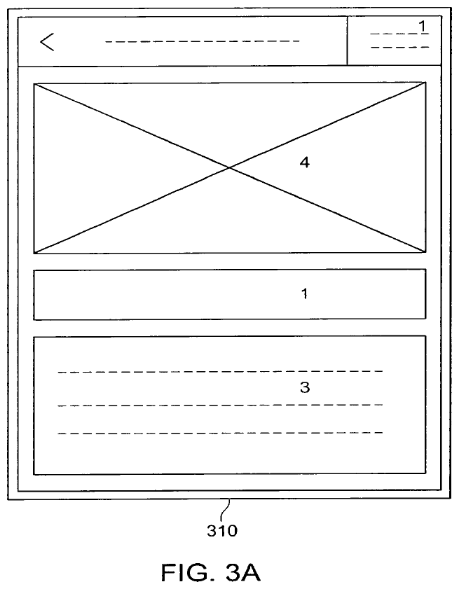

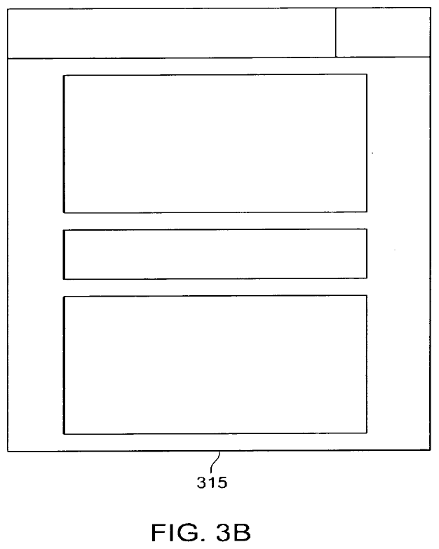

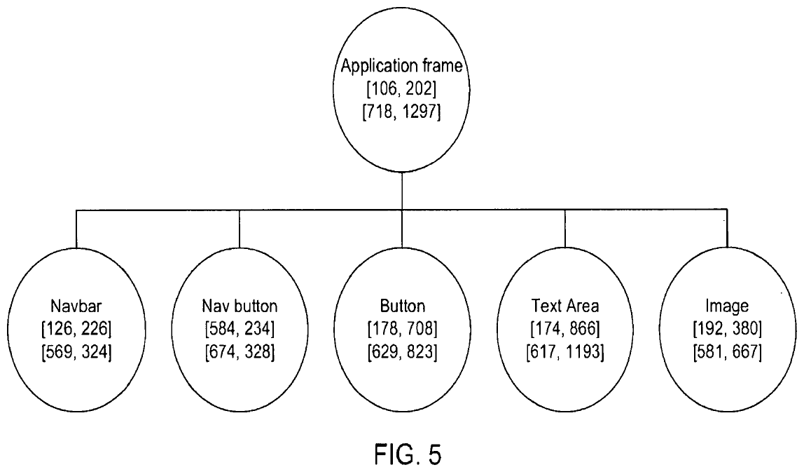

Once the platform is selected or identified, the matching/mapping process of the Generator 120 starts. As an initial matter, it analyzes the input from the Recognizer 110, such as buttons, navigations, multimedia components, or other components and their positions and sizes on the screen to establish a navigational map of the top left and bottom right corners of each component. The resulting “map” is then used by the Executor 130 to generate the code associated with creating the identified components using those stored coordinates, and building a hierarchy of those components. This code is, in practice, a JSON object describing a component tree as shown in FIG. 5, derived from the image in FIG. 3A, and it would look like this:

{

“type”: “app_frame”,
“top_left”: [106, 202],
“bottom_right”: [718, 1297],
“children”: [

{

“type”: “navbar”,
“top_left”: [126, 226],
“bottom_right”: [569, 324],

},
{

“type”: “nav_button”,
“top_left”: [584, 234],
“bottom_right”: [674, 328],

},
{

“type”: “button”,
“top_left”: [178, 708],

This notation was selected as the most commonly used and suitable for programmatically describing the structure of a web or mobile application's screen but of course other similarly functional notations could be used.

The last step is the Executor 130 that receives the description of the contents of the image as provided by the Generator 120, turning it into usable piece of software. Based on the input device and/or user selection, it will provide a code package that could be run on different platforms, such as iOS™, Android™ or a Web browser. Based on the platform, the Executor 130 will generate several text files containing the necessary code to have a functional piece of software. For example, if we're to generate a Web page, we'll have at least 3 files, containing the markup, style and logic (HTML, CSS and JavaScript, accordingly). The markup and styles will be generated from the data provided by the Generator 120 to create the layout of the page. The logic file will contain various empty event handler functions for each of the page components, such as clicks, keyboard input, form submissions etc. These will be populated as the user decides how each event should be handled for each element. The rest will be removed from the final code package. The resulting generated software will have functionality and design that could be further edited by the user, to further enhance and add additional functionality to the generated software with minimum effort.

Although several preferred embodiments of this invention have been described in detail herein with reference to the accompanying drawings, it is to be understood that the invention is not limited to these precise embodiments, and that various changes and modifications may be affected therein by one skilled in the art without departing from the scope of spirit of the invention as defined in the appended claims.

I claim:

1) A method for automating software code development comprising the steps of:
a) Capturing at least one image of a written layout and preparing the input for analysis;
b) Detecting and classifying one or more the UI elements in the captured image;
c) Converting the detected and classified elements in the image this data into a descriptive language;
d) Aligning the detected elements into a format that is compatible with one or more selected target device(s) and transmitting a file setting forth the classified elements and format(s);
e) Formatting the output of step (d) and mapping the location of the detected elements to the screen output of the selected target devices, as well as their type other applicable attributes; and
f) Generating software code required to display the output and mapped location on the designated platform(s).

2) The method of claim 1, wherein the step of capturing an image includes the step of maximizing contrast for analysis.

3) The method of claim 1, wherein the step of capturing at least one image includes applying one or more noise cancellation algorithms to such image to enhance the step of detecting and converting such image(s).

4) The method of claim 1, wherein the descriptive language is JSON.

5) The method of claim 1, wherein the step of formatting the output into a type includes designating a given element as either an image, interactive button, text input or menu item.

6) A system for automating software code development comprising the following components:
a) A Recognizer capable of receiving one or more image(s) and identifying key forms of the digital image, characteristics and attributes and generating descriptive language applicable to such forms, characteristics, and attributes;
b) Logically connected thereto, a code Generator that takes the descriptive language output of the Recognizer and maps the given output into one or more target environment(s) based on the characteristics and attributes disclosed in such descriptive language output from the recognizer; and
c) Logically connected to such Generator, an Executor that processes the output of the Generator and runs the output in one or more selected environments.

7) The system of claim 6, wherein the Recognizer is able to capture an image of a sketch on a piece of paper.

8) The system of claim 7, wherein the Recognizer is a mobile phone or camera that is capable of capturing the image and includes software for processing such image.

9) The system of claim 6, wherein the Recognizer include neural network software for optimizing image and attribute recognition.

10) The system of claim 9, wherein the neural network incorporated in the Recognizer in Faster RCNN.

11) The system of claim 10, wherein the Recognizer generates an array of objects and coordinates using Python.

12) The system of claim 6, wherein the Generator includes a list of attributes and characteristics and one or more target devices in order to optimize display and functionality of such target device.

13) The system of claim 11, wherein the Executor further includes software capable of mimicking the look and feel of one more target devices for display.
